(19) United States
(12) Patent Application Publication
(10) Pub. No.: US 2002/0161890 A1
(43) Pub. Date: Oct. 31, 2002

(54) System and method for intelligently distributing content over a communicatons network

(76) Inventor: Kailai Chen, Morganville, NJ (US)

Correspondence Address: FULBRIGHT & JAWORSKI, LLP, 666 FIFTH AVE, NEW YORK, NY, 10103-3198, US

(21) Appl. No.: 10/026,011

(22) Filed: Dec. 21, 2001

Related U.S. Application Data
(60) Provisional application No. 60/258,098, filed on Dec. 22, 2000.

(51) Int. Cl. G06F 15/173; G06F 15/16

(52) U.S. Cl. 709/226; 709/203

(57) ABSTRACT

A method and system for intelligently distributing content over a communications network to efficiently publish, delete and restore content on a web site. The system and method provides zero-down time publishing and consistent content during the updating (publishing, deleting or restoring) process.

### RELATED INFORMATION

This application is a continuation-in-part application of U.S. provisional application Serial No. 60/258,098 filed Dec. 22, 2000, which is incorporated by reference in its entirety.

### BACKGROUND OF THE INVENTION

The present invention relates to the field of web site management. More particularly, the present invention relates to a system and method for efficiently publishing, deleting and restoring the content of a web site.

The evolution over the past twenty years of digital communications technology has resulted in a mass deployment of distributed client-server data networks, the most well known of which is the Internet. In these distributed client-server networks, clients are able to access and share data or content stored on servers located at various points or nodes on the given network. In the case of the Internet, which spans the entire planet, a client computer is able to access data stored on servers located anywhere on Earth. These content are stored in a number of different content formats, such as HTML, XML, CGI, streaming audio or video, etc.

With the rapid proliferation of distributed data networks such as the Internet, an ever-increasing number of clients from around the world are attempting to connect to and access data stored on a finite number of servers. For example, web site owners and/or operators that deploy and maintain servers containing web pages from their popular web sites are finding it increasingly difficult to ensure that the end users access the most recent data.

Managing the static content of a web site can become an overly complicated matter when the site has to ensure that end users always access the most recent data. End users have increasingly demanding expectations of web sites in general, and failing to meet, let alone exceed these expectations, means weakened brand reputation, lost customers and lost revenue. One lost shopping cart or connection and a potential customer or repeat visitor to a web site may click a single button to a competitor's site.

As the Internet becomes not only the foundation of all aspects of e-business, but also one of the fundamentals keys to the success of brick-and-mortar businesses today, Internet-based communications will increasingly rely on efficient, powerful, scalable and reliable websites. Website performance plays a vital role in retaining or increasing market share.

Reliability is at the heart of any Internet solution. As web site data is updated, it is imperative that end users never access stale content after new content is published on any servers in a cluster. This means that there should never be a condition where end users can access updated information at a server and then a moment later access old material at a different server. This demand for reliability and high performance of a site means that a successful static content solution system must be implemented within a comprehensive architecture of the present invention.

As a partial solution to this problem, the web site owners and/or operators have taken draconian action of completely shutting down their web server cluster to update the static content. That is, all of the servers in the cluster are completely shutdown to ensure that the stale content is inaccessible to all end users. To reduce the impact of such shutdown or disruption of service, the web site owners generally schedule such content updates on off-peak hours, such as midnight. Therefore, it is desirable to provide a method and system that updates content without disrupting the service, and ensures the integrity of the content in the web server cluster.

Other conventional static content solutions have attempted to avoid this complete disruption of service problem by directing the end users to only fresh content. However, these conventional static content solutions are very limited in directing the end users to fresh content because they are not generally integrated with a load balancing solution. Accordingly, the end users have no guarantee against accessing fresh content one moment, and then a moment later accessing the stale version of the same content from a server with outdated information.

One prior art solution for limiting end user access to stale content is to lock end users into a single server for a defined period of time. More specifically, when the end users access new content that is currently being updated, the end users are locked into a specific server for a period of time that is slightly longer than the processing time for a content update. In this way, all client requests for such “currently being updated content” are directed to that specific server. This methodology effectively prevents the end users from accessing stale content on any other server, while the content is being updated in the servers. After the specified time period has elapsed, the end user is no longer locked to a specific server, unless the end user accesses another content file that is in the process of being updated. Although, this solution for locking the end users in to a single server resolves the static content issues, it limits the performance of the load balancing solution operating at the web site and may potentially provide degraded levels of service to end users. This prior solution utilizes the persistency features of a load balancer to lock end users into a single server but does not communicate content status awareness information between the load balancer and the static content solution to achieve optimal site reliability and performance.

The performance of any load balancing solution revolves around correctly assigning the healthiest servers to client requests as they arrive at a site. The prior art static content solutions cannot guarantee that end users never access stale content. When features have been implemented that attempt to accomplish this, such as locking end users to a single server during an update, conflicts with a load balancer's server selection process and/or persistency policies are created. Such conflicts degrade the reliability and performance of the load balancer in proportion to the amount of data being updated.

Quality of service for end users requires that they do not access stale content, and the prior art solutions, such as locking individual end users into a single server for any length of time, places them at the mercy of the individual server. In case of server failure, the end user may potentially access stale content. For overload conditions on a specific server, the end user may experience poor levels of service from the site.

Static content solutions that attempt to resolve static-content access issues must work hand-in-hand with the load balancer. The load balancing solution must be aware of the static content solution's method of operation, e.g., the two solutions should be interoperable. This is especially true when a site has high persistency requirements for end-user access to dynamic content and applications, as described in co-pending patent application Ser. No. 09/730,259 filed Dec. 5, 2000. The complexity of various persistency solutions for Internet sites requires that a site implement a static content solution that does not interfere with the functioning of other site solutions.

A static content solution that operates independently of a load balancing solution at a site can actually cause overload conditions on specific servers. This could arise from inherent conflicts in the implementation of the two solutions. A content solution that binds end users to specific servers creates persistency issues that may conflict with built-in persistency features of the load balancing solution, while the increase in persistent-connections increases chances that specific servers may become overloaded and potentially fail.

The primary purpose of all Internet solutions, including static content awareness, is to increase site speed, availability and reliability. Deficiencies are becoming increasingly unacceptable to web site owners, web site operators and end users. The static content solution must inter-operate with the load balancing solution and in no way limit the site performance for end users.

Therefore, it is desirable to provide a system and method, which considers the status of the content on specific servers, i.e., static content awareness, to intelligently distribute content over a communications network.

### SUMMARY AND OBJECTS OF THE INVENTION

Therefore, it is an object of the present invention to provide a method and system for intelligently distributing content that overcomes the shortcomings of the prior art.

In accordance with an embodiment of the present invention, the method and system, as aforesaid, efficiently publishes, deletes and restores the content of a web site.

In accordance with another embodiment of the present invention, the method and system, as aforesaid, operates with a load balancer to intelligently distribute content to the web server cluster.

In accordance with yet another embodiment of the present invention, the method and system, as aforesaid, provide zero down time publishing of content.

In accordance with still another embodiment of the present invention, the method and system, as aforesaid, provide consistent content during the updating (publishing, deleting or restoring) process.

In accordance with still yet another embodiment of the present invention, the method and system, as aforesaid, publish content even when certain servers in the cluster are out of service due to maintenance or failure.

In accordance with a further embodiment of the present invention, a method and system provide flow update integrity, site recovery and rollback, scheduling of updates, content independence, regular and atomic content updates.

In accordance with an aspect of the present invention, an intelligent content distributor intelligently updates content in a server cluster having a plurality of servers to provide consistent data. The intelligent content distributor comprises: a console for generating a job for updating the cluster with the content, a scheduler for scheduling the job, and an executor for executing the job for each server in the server cluster. The job comprises: storing pre-existing content on a server that is being updated in the intelligent content distributor, updating each server with the content, and determining if a predetermined server threshold has been met for the content. The load balancer inhibits an updated server from accepting requests until the predetermined threshold has been met. If the predetermined threshold has not been met, the executor restores the pre-existing content to each server and enables servers to accept requests for the pre-existing content.

In accordance with another aspect of the present invention, an intelligent content distributor intelligently updates content in a server cluster having a plurality of servers to provide consistent data. The intelligent content distributor comprises: a console for generating a job for updating the cluster with the content, a scheduler for scheduling the job, an executor for executing the job for each server in the server cluster, wherein said comprises: storing pre-existing content on a server that is being updated in a temporary location, updating each server with the content, inhibiting the server from accepting requests for the content and redirecting requests for the content in the server to the temporary location, and determining if the content has been successfully updated on each server. The executor stores the pre-existing content in the intelligent content distributor and enables the servers to accept requests for the content if it is determined that the content has been successfully updated to all of the servers. However, if the content has not been successfully updated, the executor restores the pre-existing content to each server and enables the servers to accept requests for the pre-existing content.

In accordance with yet another aspect of the present invention, the method for intelligently updating content in a server cluster having a plurality of servers to provide consistent data, comprising the steps of: (a) storing pre-existing content on a server that is being updated in a temporary location;(b) updating said server with said content; (c) inhibiting said server from accepting requests for said content and redirecting requests for said content in said server to said temporary location; (d) repeating steps (a) and (c) until each server is updated; (e) determining if said content has been successfully updated on each server; (f) storing said pre-existing content in a staging server and enabling said server to accept requests for said content if it is determined that said content has been successfully updated; and (g) restoring said pre-existing content to each server and enabling said server to accept requests for said pre-existing content if it is determined that said content has not been successfully updated.

In accordance with still another aspect of the present invention, the method for intelligently updating content in a server cluster having a plurality of servers to provide consistent data, comprising the steps of: (a) storing pre-existing content on a server that is being updated in a staging server; (b) updating said server with said content; (c) inhibiting said server from accepting requests for said content by a load balancer; (d) determining if a predetermined server threshold has been met for said content; (e) permitting said server from accepting said requests and inhibiting servers that has not been updated with said content from accepting requests if it is determined that said predetermined server threshold has been met; (f) repeating steps (a) and (e) until each server is updated; and (g) restoring said preexisting content to each server and enabling said server to accept requests for said pre-existing content if it is determined that said predetermined server threshold has not been met.

Various other objects of the present invention will become readily apparent from the ensuing detailed description of the drawings.

### BRIEF DESCRIPTION OF THE DRAWINGS

The following detailed description, given by way of example, and not intended to limit the present invention solely thereto, will be best be understood in conjunction with the accompanying drawings:

FIG. 1 is a functional block diagram of a system incorporating an intelligent content distributor of the present invention;

FIG. 2 is a block diagram illustrating the updating process in accordance with an embodiment of the present invention;

FIG. 3 is a flow diagram illustrating the process by which the console, scheduler and executor of the intelligent content distributor updates content in accordance with an embodiment of the present invention;

FIG. 4 is a flow diagram illustrating the rescheduling process in accordance with an embodiment of the present invention; and

FIG. 5 is a flow diagram illustrating the content rollback process in accordance with an embodiment of the present invention.

### DETAILED DESCRIPTION OF THE EMBODIMENTS

The present invention is readily implemented using presently available communication apparatuses and electronic components. The invention finds ready application in virtually all communications systems, including but not limited to intranet, local area network (LAN), wireless LAN (WLAN), wide area network (WAN), Internet, private or public communication networks, wireless networks, satellite networks, cable networks or other online global broadcast networks.

To prevent any conflicts with the web site's load balancing solution, the present invention provides a system and method of intelligently distributing content to the web server cluster that considers the status of the content on the specific servers of the web server cluster without locking the end users to a single server. The system and method of the present invention provides flow update integrity, thereby ensuring that all end users access fresh content from the web server cluster.

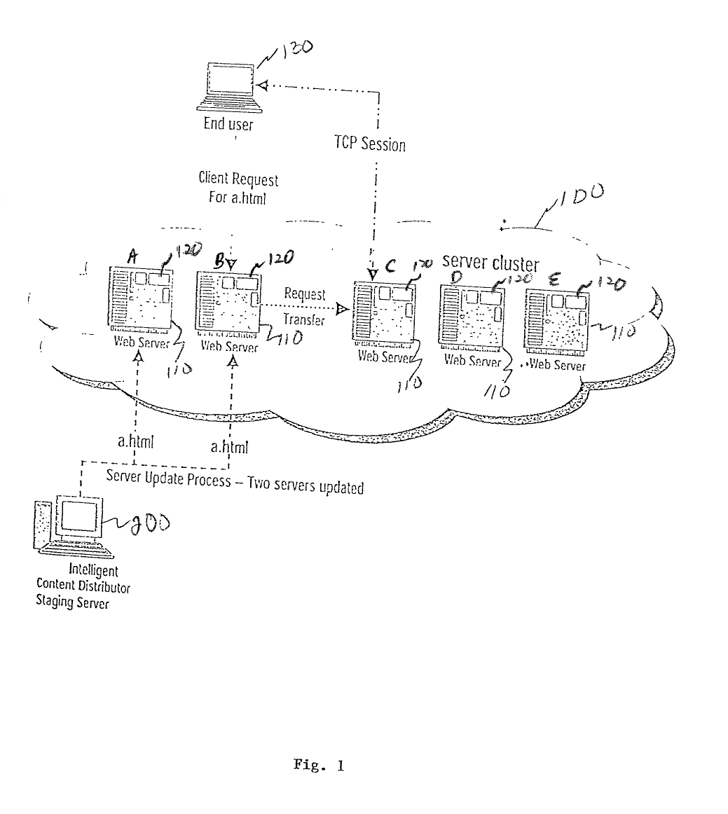

Turning now to FIG. 1, there is illustrated a system for intelligently distributing content over a communications network. When fresh content is published and becomes accessible to the end users 130 via some site servers 110, the intelligent content distributor 200 of the present invention informs all servers 110 in the cluster 100. The stale content on servers 110C, 110D, 110E that have not yet been updated immediately become inaccessible and client requests for that specific content are transferred to servers 110A, 110B containing the fresh content. However, it is appreciated that the flow update integrity feature of the present invention only prevents client requests for stale content from entering an un-updated server, such as server 110C. Client requests for other fresh content files on a server that has some stale content are serviced normally.

The present invention provides a system and method for efficiently publishing, deleting and restoring the content of a web site. The intelligent content distributor 200 of the present invention can be incorporated seamlessly into a comprehensive web site architecture and functions without needing any network re-configurations. Preferably, the system and method of the present invention is designed to operate on Open System Interconnection (OSI) layers 1-7. OSI is an International Organization for Standardization (ISO) standard for worldwide communications that defines a networking framework for implementing protocols in seven layers. Control is passed from one layer to the next, starting at the application layer in one server, machine or station, proceeding to the bottom layer, over the channel to the next station and back up the hierarchy. The intelligent content distributor 200 can schedule jobs for any time including peak usage hours without any interruptions in service at a web site. Each job specifies a group of servers to update, when to update them and what files to publish, delete or restore on the servers.

While critical jobs can be performed quickly and reliably at any time, all other jobs can be scheduled for times of minimal site usage and reviewed at a later time once the job is finished. The intelligent content distributor 200 of the present invention can perform jobs late at night without the presence of on-site personnel. This minimizes the high costs and headaches associated with manually publishing, deleting or restoring content at a site. The intelligent content distributor 200 controls the update process across a site's web servers 110 and tracks every job. Every step of the update process is logged for each job. Preferably, the intelligent content distributor 200 can create report files which can be viewed by the web site operator to check the status of each job.

The success or failure for each file being published, deleted or restored in a job is tracked and saved in an extensible markup language (XML) output task file for each job. The job tracking and storing operation allows the points of success or failure for each job to be reviewed at a later time. After the web site operator gets a report file displaying the status of each job, the operator can locate any specific job that may have failed and its corresponding XML output task file. Then, the operator can review the XML output task file to find out why the job did not succeed. Corrective actions can then be taken with minimal effort and resources for any errors in the recently executed updates at a site.

XML is a pared-down version of standard generalized markup language (SGML), designed especially for web documents. It allows designers to create their own customized tags, enabling the definition, transmission, validation, and interpretation of data between applications and between organizations. XML enables one to exchange information over the Internet from one format to another without altering the information itself As opposed to describing the actual data comprising a file, XML defines the varying types of data that a particular file can contain or receive.

In accordance with an embodiment of the present invention, the intelligent content distributor 200 provides reliable ways to distribute content to web server clusters 100. The intelligent content distributor 200 of the present invention supports virtual host based publishing, reliable distribution, automatic retry, rollback and restore, scheduling, and atomic content grouping. It also provides an intuitive browser based graphic user interface (GUI) interface which allows clients to publish content from anywhere.

As shown in FIGS. 1, 2 and 3, in accordance with an embodiment of the present invention, the intelligent content distributor 200 comprises the following software components: a console 210, a scheduler 220 and an executor 230. The console 210 process all jobs, checks their validity, and sends them to the 220 scheduler to be scheduled. The scheduler 220 schedules the jobs for execution and reschedules any jobs containing update errors if the particular job is configured for retries. The executor 230 executes jobs on the specified web servers, i.e., content clusters. Preferably, the executor 230 references the XML configuration file to determine which web servers belong in the content clusters it has to update. An XML configuration file defines each web server 110 for the intelligent content distributor 200, configures the web servers 110 into content clusters, defines loop-times for the scheduler 220 and executor 230, and informs the intelligent content distributor 200 where to save the log files.

The intelligent content distributor 200 utilizes an XML task file to publish new files, restore backed up files and delete any files that are no longer needed. The task of publishing, deleting or restoring one or more files/directories 140 to one or more web servers 110 is collectively referred to herein as an “update”. The XML task file allows the operator to specify what content to update to a web server 110 and whether to update the content atomically or non-atomically (as described herein). The XML task file specifies the data required for individual jobs, such as all the tasks, the date and time the intelligent content distributor 200 has to perform the job, the number of times it has to re-attempt the job if the job fails to update successfully, the server threshold for the job, whether or not the job is atomic or non-atomic, etc. A job consists of multiple tasks, actions and other data, such as the server threshold, and directs the intelligent content distributor 200 to perform an update in the desired manner. The console 210 processes the job from the XML task file and sends the job to the scheduler 220. The scheduler 220 sends the job to the executor's queue (not shown). At the scheduled time, the executor 230 executes the job using the data from the XML configuration and task files.

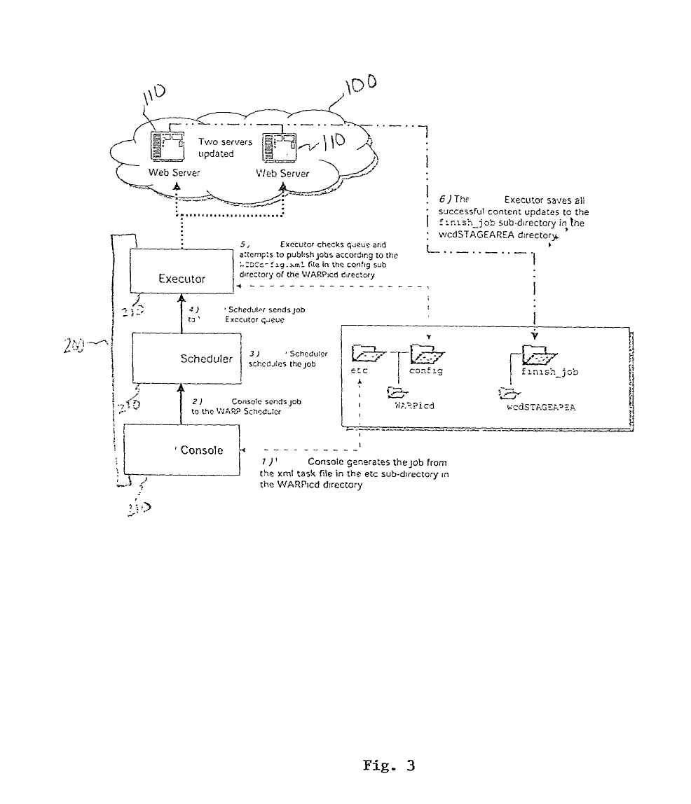

When the executor 230 carries out an update, the executor 230 checks the data contained in the XML configuration file, such as the WCDConfig.xml file, and combines the data with the information contained in the XML task file to execute the job according to the specifications of the web site owner/operator. As shown in FIG. 3, if a job is successful and can be fully executed, the intelligent content distributor 200 saves the job in a sub-directory called finish_job, which resides in the wcdSTAGEAREA directory.

The intelligent content distributor 200 saves all the files containing web site content in a sub-directory called “src”, which resides one level below the wcdSTAGEAREA directory. Also, the intelligent content distributor 200 creates backups of all original jobs and saves them in a sub-directory called job_archive which resides one level below the wcdSTAGEAREA directory on the staging server.

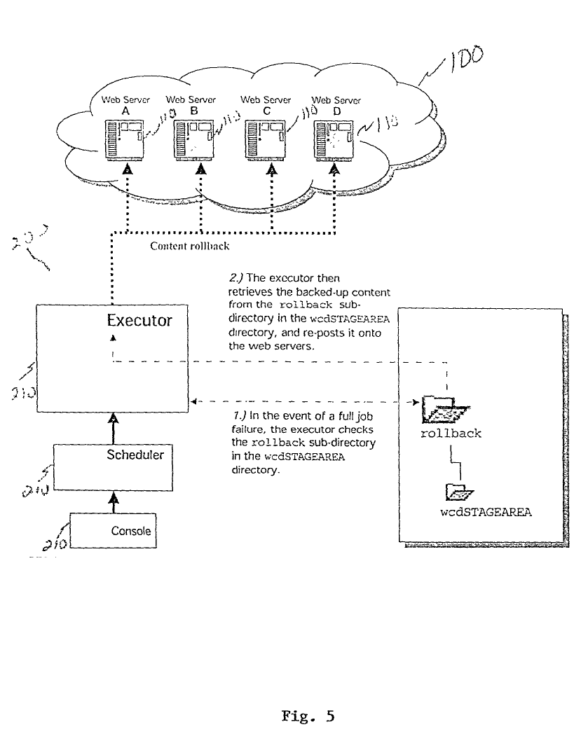

Prior to successfully updating a web server 110 with the updated site content, the intelligent content distributor 200 backs up all the content being replaced to the rollback sub-directory in the staging directory. The intelligent content distributor 200 keeps any pre-existing web site content being replaced on reserve in case a rollback needs to be performed for an unsuccessful update as illustrated in FIG. 5.

The operator can create and edit the XML task files to specify the content to update as long as the correct XML formatting is maintained with the provided XML tags. For example, the intelligent content distributor 200 can utilize the following XML parameter tags:

| | | | Required for |
|---|---|---|---|
| | | Required for | non-atomic |
| XML Tag | Description | atomic updates | updates |
| <warptask> | Initiates task and encloses all task file data | Yes | Yes |
| <parameters> | Encloses all update parameters for every task | Yes | Yes |
| | in the job | | |
| <sched_date> | Date: yyyymmdd or mm/dd/yyyy | Yes | Yes |
| <sched_time> | Time: hr:min:sec or hr:min:sec am/pm | Yes | Yes |
| <num_retry> | Number of retries attempted by the excutor | Optional; | Option; default |
| | 230 | default is 1 | is 1 |
| <threshold> | Sets server threshold. If this tag is omitted | Optional | Optional |
| | from the XML task file 140, default value for | | |
| | this threshold is set to 50% | | |
| <dir_policy> | Enables WARP Intelligent Content | Optional | Optional |
| | Distributor to automatically create new task | | |
| | file directories on the content servers. This | | |
| | tag can be set to: true/false (equivalent to | | |
| | ‘on/off’) - default is true. | | |
| <atomic_policy> | Atomic/Non-atomic: true/false (equivalent to | Yes | Yes |
| | ‘on/off’). If you want to perform an | | |
| | atomic update, make sure the value of this | | |
| | tag is set to true . If you want to perform a | | |
| | non-atomic update, make sure this tag is set | | |
| | to false. | | |
| <atomic_cluster> | Specifies the cluster receiving an atomic | Yes | This tag is |
| | update | | ignored for |
| | | | non-atomic |
| | | | jobs |
| <tasklist> | Encloses all task in a given content update | Yes | Yes |
| <task> | Start of an individual task | Yes | Yes |
| <action> | Action (PUBLISH, DELETE, RESTORE) | Yes | Yes |
| <src> | Indicates the file or directory on the staging | Required only | Required only |
| | server (i.e., intelligent content distributor | for publishing | for publishing |
| | 200) that is going to be updated to the web | jobs | jobs |
| | servers 110 | | |
| <dest> | Specifies the file or directory on the web | Required for | Required for |
| | servers 110 that is going to be updated | deleting and | deleting and |
| | | restoring jobs | restoring jobs |
| <cluster> | Specifies content cluster being updated | The <cluster> | Yes |
| | | tag is ignored in | |
| | | atomic updates | |

When the intelligent content distributor or staging server 200 initiates a content update to the web or content servers 110, only the new content files/directories on the updated servers 110-A and 110-B in FIG. 1 are inaccessible, and only until a certain percentage of the servers 110 in the cluster 100 are updated. More specifically, although the new content on the updated servers 110 are inaccessible, the servers 110 themselves are accessible for other content stored therein. This specific threshold is a configurable parameter that can be set to the percentage of servers 110 that need to be updated successfully before new content is accessible to client requests. Until the threshold is met, the old content on the servers 110 that have not yet been updated is still accessible for client requests.

For example, as shown in FIG. 1, if a server cluster 100 of five servers 110A-110E needs to be configured so that a minimum of two servers 110 are available to accept client requests for specific content from the end user 130, then the threshold would be set to 40%. This way, new content is inaccessible until two servers 110A, 110B have been updated completely.

When the threshold value is low, fewer servers 110 are initially available to service client requests for the new content, but other servers 110 quickly come online as they are updated. When the threshold value is high, more servers 110 are initially available to service client requests for the new content.

The threshold value can be tailored to the requirements of individual sites. A common value at which to set the threshold is 50%, because this ensures that at least half the servers 110 are always available to service client requests for content from the end users 130 during the content updating process.

Once the threshold value for the file has been met, a switch is performed and the new content on two servers 110A, 110B—as in this example—is now accessible, and the stale content on the other three servers 110C, 110D, 110E is then inaccessible until the new content is published to them. This process works the same way for atomic content update jobs, except that all the content files in the group must be successfully published to a server before the update for that server is considered complete.

If a single file fails to publish correctly in an atomic content update job, the whole update is considered unsuccessful and a rollback to the old content is performed for the entire update. When individual content files fail to publish during a non-atomic update job, a rollback to the old content for only that specific file is performed, while the rest of the content associated with the non-atomic update job is published to the servers 110. Once a switch takes place for any content, all requests for this content are served by the new content so that no end users access the old content.

When the number of the currently available servers is equal to the threshold value, the update process pauses before attempting to update the last available server since this would temporarily make the content being updated unavailable for client requests. In accordance with an embodiment of the present invention, the intelligent content distributor 200 performs a forward check on the last server 110 to ensure that it is functioning properly and then performs a switch before updating the last available server 110. This advantageously ensures that the content remains available for client requests at all times. If the number of available servers 110 is ever less than the threshold value, no updates are performed.

As shown in FIG. 5, if the switch from the old to new content cannot be performed successfully for whatever reason, a rollback to the old content is performed, and the update for that content is registered as unsuccessful, i.e., a full job failure. This occurs when files are not properly updated or server failures have lowered the number of available servers below the threshold limit. For example, an update initiates in a cluster 100 with six servers 110 and a threshold of 50%. The update fails on four servers 110 in the cluster 100, which means that the threshold limit of three servers 110 cannot be reached for this update. At this point a rollback to the old content is performed. Since the switch was never performed, end users never accessed the new content during the update process.

The content update rollback process is delineated in FIG. 5. If the intelligent content distributor 200 cannot meet the threshold number of web servers for either an atomic or a non-atomic update (i.e., a full job failure), the executor 230 checks the rollback sub-directory in the wcdSTAGEAREA directory residing in the staging server or the intelligent content distributor 200. Thereafter, the executor 230 retrieves the old content that was backed up immediately before the beginning of the update process from the backup sub-directory (i.e., the rollback subdirectory in the wcdSTAGEAREA directory) and re-posts that old content onto the servers 110A-110D.

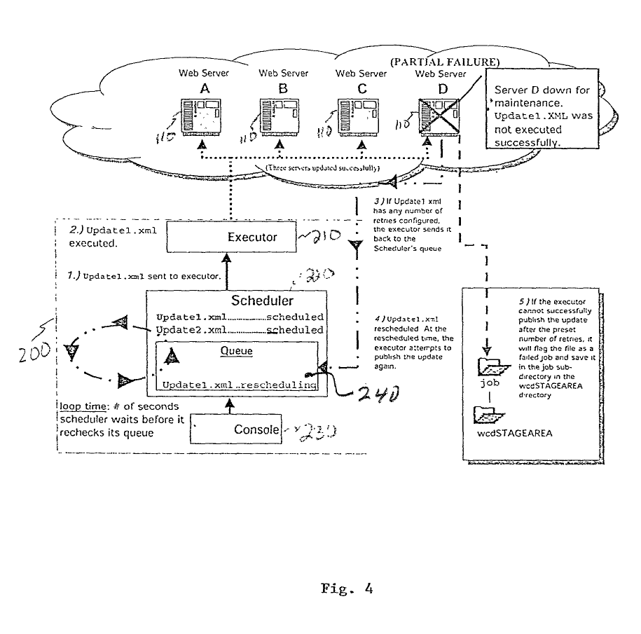

The intelligent content distributor 200 will retry each update job according to the number of user-selected retries for which each specific update job has been configured. The process of rescheduling a job is shown in FIG. 4. If a job fails or is only partially successful and is configured to be retried, the executor 230 sends the job back to the scheduler 220, which sends the job back to the executor's queue with a new date and time, set to five minutes after the first unsuccessful attempt. Preferably, the amount of time that passes between each successive update attempt lengthens in five-minute increments. That is, the scheduler 220 establishes a loop time, number of seconds the scheduler 220 waits before re-checking its queue 240. If the first rescheduling attempt fails, the job is re-attempted or re-scheduled ten minutes after the failure by the scheduler 220. If the second rescheduling attempt fails, the job is re-attempted or re-scheduled fifteen minutes after the failure by the scheduler 220. This continues until the number of set retries are exhausted. Should all the retries fail, the executor 230 flags the job as an error and saves the job in the “/opt/wcdSTAGEAREA/job” directory. The output XML task file saved in this directory contains the tasks which failed, partially failed or succeeded.

In accordance with an embodiment of the present invention, the intelligent content distributor 200 is aware of all server failures and/or servers 110 that are disabled for maintenance purposes. All update jobs for a cluster 100 are tracked for failed and/or disabled servers 110 in the cluster 100, such as the server 110-D in FIG. 4. When a failed or disabled server 110-D comes back online, the intelligent content distributor 200 is aware of all the out-of-sync content files on the servers 110. These files are automatically inaccessible until the intelligent content distributor 200 updates the recovered server 110-D with the new content files for all the update jobs that it missed.

Atomic is a job level parameter that directs the intelligent content distributor 200 to update all the content files in a job as a single group. An atomic job is performed as a single update with multiple files and actions, i.e., they succeed or fail together on each server. A single failure, i.e., individual file or task failure, causes a rollback to the original content on a server. If the threshold for an atomic update is not met, all the files in the job are rolled back as a group. In other words, none of the content files are updated on any of the web servers 110. For example, the intelligent content distributor 200 performs the following steps for publishing content atomically:

1. The intelligent content distributor 200 temporarily backs up any pre-existing content on the web server 110 that is being updated to the rollback directory.

2. The intelligent content distributor 200 attempts to update the servers with the grouped content files 140. For a particular job, if even one file 140 fails to update on a server 110, the content previously on the site before the update is rolled back to the server 110.

3. If the server threshold is met, the content switch is performed for all the files 140. The backed-up content is moved from the rollback directory to the backup directory on the staging server 200. All the tasks for the files 140 are listed as either a success or partial failure in the output XML task file depending on whether every server 110 was successfully updated.

4. If the threshold is not met, the original content is rolled back to all the web servers 110 and all the tasks for the files 140 are listed as a failure in the output XML task file.

5. If any tasks partially or completely failed, the job is re-scheduled so that the executor 230 can attempt to update the tasks again. If the job has no retries configured, its status is listed as an error in the job report.

The following is a sample task file that can be modified by the operator for an atomic update job (the operator can plug in the specifications between the appropriate XML tags and delete any unnecessary data):

<?xml version=“1.0” encoding=“iso-8859-1”?>
<!DOCTYPE warptask SYSTEM “/opt/WARPicd/bin/../dtd/WarpTask.dtd”>

<!--Thxmlirst two lines are required data that is generated during installation. Only alter this
information if you change the location of the WARPicd base directory.-->

<warptask>

<!--Initiates the execution of a content update.-->

<parameters>

<!--Defines the parameters section that contains the information WARPicd needs to execute
an update job.-->

<atomic_policy>true</atomic_policy>

<!--Specifies whether the update job is atomic (true) or non-atomic (false). In an atomic job,
WARPicd attempts to update one server at a time with all the tasks, i.e., all update tasks in an
update job must succeed on a server to deem that server successfully updated. The threshold
is applied to the update job as a whole. For a non-atomic job, WARPicd attempts to update all
the servers with each individually task (file update - a directory update is broken down into
individual tasks for each file in the directory, i.e., each file update succeeds or fails
individually on the servers. The threshold is applied to each updating file individually.-->

<atomic_cluster>cluster1</atomic_cluster>

<!--Defines which content cluster to update. You can only select one content cluster per
atomic update job. Content clusters are defined in the WCDConfig.xml file. If any <cluster>
tags are entered in the tasks, they are ignored for atomic updates-->

<sched_date>20001115</sched_date>

<!--Specifies the date when the update job will take place. Format: YYYYMMDD, where
'Y'=Year, 'M'=Month, and 'D'=Day.-->

<sched_time>2:10:00AM</sched_time>

<!--Specifies the time of day when the job is scheduled to execute (in hours, minutes, and
seconds). You can set the execution time to AM, PM, or according to military time.-->

<dir_policy>true<dir_policy>

<!--Turning the direct policy on (true) allows WARPicd to create directories on the servers it
is updating if a directory in the new content does not already exist on the server. Set the
policy to 'false' to turn it off. We recommend that you set this policy to 'true'.-->

<threshold>50</threshold>

<!--Specifies the percentage of servers that need to update successfully (rounding up) before
new content is accessible to end users. Enter a numeric value for this parameter tag.-->

<num_retry>3</num_retry>

<!--Specifies how many times WARPicd retries an update job before flagging the job as
failed and sending it to the error queue. Set the <num_retry> tag to a numerical value.-->

</parameters>
<tasklist>

<!--Defines the tasks that WARPicd attempts to perform for the atomic update job.-->

<!-- The below task will publish the source file containing web site content to the document root
directory created by the WARP Intelligent Content Distributor. -->
<task>

<!--Prepares WARPicd to perform a single action pertaining to an update job. In order to
perform any action, the <task> tag must be positioned before the <action> tag.-->

<action>PUBLISH</action>

<!--Specifies whether the task is for publishing (PUBLISH), deleting (DELETE), or restoring
(RESTORE) content. These actions are not case sensitive. Restore tasks can only be
performed for content that has been previously backed up by WARPicd.-->

<src>/export/home/user_dir/file</src>

<!--Specifies the source file or directory on the staging server. You need to specify the full
path of the source file/directory to successfully perform an update job. This is a required field
for publishing.-->

<dest>/</dest>

<!--Defines the directory and/or filename that WARPicd attempts to publish to. This
parameter is not required for publishing. If a file destination is not specified when publishing,
the source directory/file will go into the document root directory on the servers being updated.
When there is a specified file destination WARPicd only publishes the contents, i.e., sub-
directories and files, of the source directory to the specified destination directory. The <dest>
tag is required for the DELETE & RESTORE functions.-->

</task>

<!--In the below task, the intelligent content distributor 200 will publish a source file
containing web site content to the root directory, but under a different file name. Notice the
‘new file name’ between the two <dest> tags.-->

<task>

<action>PUBLISH</action>
<src>/export/home/user_dir/file</src>
<dest>new_file_name</dest>

</task>

<!--The task shown below will publish the source file to directory_name in the root directory.
The name of this file will remain unchanged. The ‘/’ after the specified directory is optional. --
>

<task>

<action>PUBLISH</action>
<src>/export/home/user_dir/file</src>
<dest>directory_name/</dest>
<!--could be ‘directory_name/file’ if so desired-->

</task>

<!--The task shown below will publish an entire directory and its sub-directories to the root
directory, however the directory will be published under a different name. The sub-directory
and file names will stay the same.-->

<task>

<action>PUBLISH</action>
<src>/export/home/user_dir</src>
<dest>different_directory_name</dest>

</task>

<!--The task shown below will publish an entire directory and its sub-directories to the
document root directory with the same directory name (user_dir).-->

<task>

<action>PUBLISH</action>
<src>/export/home/user_dir</src>

</task>

<!--The task shown below will publish all the sub-directories and files in usr_dir to the
document root directory.-->

<task>

<action>PUBLISH</action>
<src>/export/home/user_dir</src>
<dest>/</dest>
<!--The destination ‘/’ directs WARPicd to publish the contents of a source directory to the
document root directory.-->

</task>

Non-atomic is a job level parameter that directs the intelligent content distributor 200 to recognize each content file in a job as an individual file. In a non-atomic job, each file in the job is updated to the web servers 110 independently. This means that each file succeeds or fails on its own, regardless of the success or failure of any of the other content files in the job. If the threshold for an update is not met for a file, it is rolled back. More specifically, only those files that fail to meet the server threshold are not updated on any of the web servers 110. For example, the intelligent content distributor 200 performs the following steps for publishing content non-atomically:

1. The intelligent content distributor 200 temporarily backs up any pre-existing content from the web servers 110 that is being updated into the rollback directory.

2. The intelligent content distributor 200 attempts to update the servers 110 with the individual content files 140.

3. When the server threshold is met for each individual file 140, the content switch is performed for that file 140, and the backed-up copy of that file 140 is moved from the rollback directory to the backup directory on the staging server 200. The task for the file is listed as a success or partial failure in the output XML task file depending on whether every server 110 was successfully updated.

4. If the threshold is not met for a file 140, the original content for that file 140 is rolled back to the web servers 110 and the task for the file is listed as a failure in the output XML task file.

5. If any tasks are partially or completely failed, the job is re-scheduled so that the executor 230 can attempt to update the partially or completely failed tasks again. If the job is not set to retry, its status is listed as an error in the job report.

The following is a sample task file that can be modified by the operator for a non-atomic update job (the operator can plug in the specifications between the appropriate XML tags):

<?xml version=“1.0” encoding=“iso-8859-1”?>
<!DOCTYPE warptask SYSTEM
“/opt/WARPicd/bin/../dtd/WarpTask.dtd”>
<warptask>
<parameters>

<atomic_policy>false</atomic_policy>
<sched_date>20001115</sched_date>
<sched_time>13:10:00<sched_time>
<dir_policy>true</dir_policy>
<threshold>50</threshold>
<num_retry>3</num_retry>

</parameters>
<tasklist>

<task>

<action>PUBLISH</action>
<src>/export/home/user_dir/file</src>
<dest>/</dest>
<cluster>cluster1</cluster>

</task>
<task>

<action>PUBLISH</action>
<src>/export/home/user_dir/file</src>
<dest>new_file_name</dest>
<cluster>cluster1</cluster>

</task>
<task>

<action>PUBLISH</action>
<src>/export/home/user_dir/file</src>
<dest>directory_name/</dest>
<cluster>cluster1</cluster>

</task>
<task>
<action>PUBLISH</action>
<src>/export/home/user_dir</src>

<dest>/different_directory_name</dest>
<cluster>cluster1</cluster>

</task>
<task>

<action>PUBLISH</action>
<src>/export/home/user_dir</src>
<cluster>cluster1</cluster>

</task>
<task>

<action>PUBLISH</action>
<src>/export/home/user_dir</src>
<dest>/</dest>
<cluster>cluster1</cluster>

</task>

</tasklist>
</warptask>

Deleting content from the web site's servers 110 operates in much the same manner as the publishing process. In deleting content, the operator specifies the location from which the file or directory is being removed from the web servers 110, i.e., specify the location in the <dest> tags in the XML task file. Preferably, when a file is being deleted, the intelligent content distributor 200 also backups the file in the backup sub-directory residing below the staging area's root directory.

In accordance with an embodiment of the present invention, the intelligent content distributor 200 permits the operator to group files together and perform an atomic deletion, or take individual files and delete them non-atomically. The following is a sample task file that can be modified by the operator for deleting content atomically (the operator can plug in the specifications between the appropriate XML tags):

<?xml version=“1.0” encoding=“iso-8859-1”?>
<!DOCTYPE warptask SYSTEM
“/opt/WARPicd/bin/../dtd/WarpTask.dtd”>
<warptask>
<parameters>

<atomic_policy>true<atomic_policy>
<atomic_cluster>cluster1</atomic_cluster>
<sched_date>20001115</sched_date>
<sched_time>2:10:00 AM</sched_time>
<dir_policy>true<dir_policy>
<threshold>50</threshold>
<num_retry>3</num_retry>

</parameters>
<task>

<tasklist>

<action>DELETE</action>
<dest>file</dest>

</task>
<task>

<action>DELETE</action>
<dest>directory/file</dest>

</task>
<task>

<action>DELETE</action>
<dest>directory</dest>

</task>

</tasklist>
</warptask>

The following is a sample task file that can be modified by the

operator for deleting content non-atomically (the operator can plug in
the specifications between the appropriate XML tags):
<?xml version=“1.0” encoding=“iso-8859-1”?>
<!DOCTYPE warptask SYSTEM
“/opt/WARPicd/bin/../dtd/WarpTask.dtd”>
<warptask>
<parameters>

<atomic_policy>false</atomic_policy>
<sched_date>20001115</sched_date>
<sched_time>13:10:00</sched_time>
<dir_policy>true<dir_policy>
<threshold>50</threshold>
<num_retry>3</num_retry>

</parameters>
<tasklist>

<task>

<action>DELETE</action>
<dest>file</dest>
<cluster>cluster1</cluster>

</task>
<task>

<action>DELETE</action>
<dest>directory/file</dest>
<cluster>cluster1</cluster>

</task>
<task>

<action>DELETE</action>
<dest>directory</dest>
<cluster>cluster1</cluster>

</task>

</tasklist>
</warptask>

In accordance with an embodiment of the present invention, the intelligent content distributor 200 enables the operator to restore old content that has been backed up to the web site's servers 110. In restoring a backed-up file or directory, the operator specifies a destination to which the backed-up file or directory is being restored. Preferably, the content can be restored atomically and non-atomically. In restoring atomic content to a web site, the intelligent content distributor 200 groups the files 140 into a single group and restores either all of the files 140 if they can be all restored successfully, or none of the files if one of the files 140 cannot be restored successfully. If the files 140 are restored non-atomically to a web site, each file 140 must meet the threshold standard independently to be restored. Like the publishing and deleting process, the intelligent content distributor utilizes an XML task file to restore content to a web server.

The following is a sample task file that can be modified by the operator for restoring atomic content to a web site's web servers 110 (the operator can plug in the specifications between the appropriate XML tags):

<?xml version=“1.0” encoding=“iso-8859-1”?>
<!DOCTYPE warptask SYSTEM
“/opt/WARPicd/bin/../dtd/WatpTask.dtd”>
<warptask>
<parameters>

<sched_time>15:00:10</sched_time>
<sched_date>20001104</sched_date>
<num_retry>2</num_retry>
<thresh>70</thresh>
<dir_policy>true</dir_policy>
<atomic_policy>true</atomic_policy>
<atomic_cluster>all</atomic_cluster>

</parameters>
<tasklist>

<task>

<action>RESTORE</action>
<dest>directory/file</dest>

</task>
<task>

<action>RESTORE</action>
<dest>directory</dest>

</task>

</tasklist>
</warptask>

The following is a sample task file that can be modified by the operator for restoring non-atomic content to a web site's web servers 110 (the operator can plug in the specifications between the appropriate XML tags):

<?xml version=“1.0” encoding=“iso-8859-1”?>
<!DOCTYPE warptask SYSTEM
“/opt/WARPicd/bin/../dtd/WarpTask.dtd”>
<warptask>
<parameters>

<sched_time>15:00:10</sched_time>
<sched_date>20001104</sched_date>
<num_retry>2</num_retry>
<thresh>70</thresh>
<dir_policy>true<dir_policy>
<atomic_policy>false</atomic_policy>

</parameters>
<tasklist>

<task>

<action>RESTORE</action>
<dest>directory/file</dest>
<cluster>cluster1</cluster>

</task>
<task>

<action>RESTORE</action>
<dest>directory</dest>
<cluster>cluster1</cluster>

</task>

</tasklist>
</warptask>

In accordance with an embodiment of the present invention, the intelligent content distributor 200 can comprise a web server plug-in (or module) to control how the client request from the end user 130 is handled for publishing content. When the intelligent content distributor 200 publishes a file to a web server 110, it informs the plug-in to copy old content to a temporary location in the web server and redirect all requests for that content to this temporary location. The intelligent content distributor 200 then sends the new content to a specific location on the server 110. This “updating” or “publishing” process continues until the new content is successfully published to every server 110 in the cluster 100. After the publishing process is completed, the redirection of client requests for that content is terminated so that the end user 130 can access the new content.

In accordance with an aspect of the present invention, the plug-in module (not shown) comprises the following modules: an initialization module, a name translation module and a service module. The initialization module initializes or setups a content redirection table or “UNAVAIL” tables (not shown) and parameters indicating whether a particular content, as identified by an uniform resource identifier (URI), is unavailable. The service module processes requests from the intelligent content distributor 200 by converting “http” requests into messages, thereby enabling the content available (CA) module to maintain the content redirection table. Based on the messages, the service module copies old or stale files to temporary locations and maintains (setups and cleans) the temporary locations.

When there is unavailable content on the current server, the name translation module examines every client requests to determine if the requested content is currently unavailable from the server 110 or the requested URI is in the content redirection table. If it is determined that the particular content is unavailable (i.e., entry is found in the redirection table), then the client request is redirected to the temporary location. This advantageously ensures that the end user 130 access the content on a consistent basis. That is, this prevents the end user 130 from accessing the updated content from one server and then a moment later accessing the stale content from a different server.

In accordance with an aspect of the present invention, the CA module returns an http response. The content will be the response message. Job-Id and message id, e.g., “myJob.20000825:02:00:00|3|server1|OK”, will be returned with an acknowledgement. An example of the name translation (NameTran) function or module is provided herein. The content available module has an Unavail_Status flag. This flag is set whenever there is any unavailable content for a current server. When a request is being processed by the name translation module and the Unavail_Status flag is not set, the name translation module returns “REQ_PROCEED” message and does nothing else since the content is available in the current server. Otherwise if the Unavail_Status flag is set, the name translation module passes the request to the CA module. If the CA module returns a Set-Unavailable message (i.e., URI is not available for the current host), the name translation module translates the URI to a temporary location, thereby providing the old content in response to the request that has been redirected to the temporary location. If CA module returns a Set-Avail message, the name translation module simply returns “REQ_PROCEED” message and does nothing else.

For Netscape™ web servers, these three functions or modules can be implemented using Netscape™ server application protocol interface (NSAPI) and written as server application functions. The following is an example of the service function or module implemented using NSAPI.

NASPI_PUBLIC int WICD_Service(pblock *pb, Session *sn, Request *rq) WICD_RequestHandler

//Parsing the request and get the intelligent content distributor (WICD) message.

//Pre-Action based on a message.

//Pass WICD message fto CA module.

//Send Response back to WICD.

Wherein a pre-action defines an action that is performed before passing the message to the content available module and a post-action defines an action that is performed after the messages is passed to the content available module.

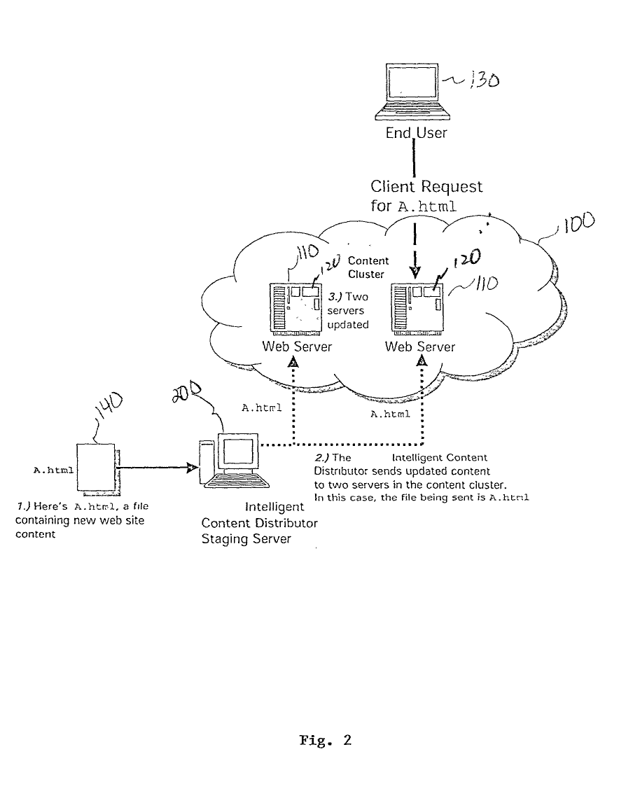

As shown in FIGS. 1 and 2, in accordance with an embodiment of the present invention, each web server 110 in the cluster 100 comprises a load balancer or load balancing module 120 which operates in conjunction with the intelligent content distributor 200 to redirect client requests for specific content away from a particular web server 110 (i.e., the server in the process of being updated or with stale data), and to operate the redirection feature (i.e., turn on or off) in real-time. Alternatively, the server cluster 100 includes a single central load balancer 120 (not shown). Accordingly, the load balancer 120 is aware of the status of the content (i.e., content status awareness) residing in its respective server 110 in order to support the redirection feature. In accordance with an aspect of the present invention, the load balancer 120 maintains a content redirection table for those specific content in the web server 110 that needs to be redirected. That is, the content redirection table contains the URI of the content that are current inaccessible on the web server 110. Based on the URI information in the client request, the load balancer 120 consults or reads the content redirection table to determine whether this particular client request (i.e., connection request) should be accepted. If the entry is found in the content redirection table, the load balancer 120 re-directs the connection or client request to another server 110 in the cluster 100.

In accordance with an embodiment of the present invention, the intelligent content distributor 200 of the present invention can be integrated with a load balancer, such as the load balancer described in co-pending U.S. patent application Ser. No. 09/728,270 filed Dec. 1, 2000, entitled “System and Method for Enhancing Operation of a Web Server Cluster, which is incorporated by reference in its entirety. It is appreciated that the intelligent content distributor 200 guarantees that end users 130 never access stale content. Using the intelligent content distributor 200 with a load balancer 120 guarantees that incoming client requests for content are load balanced among the servers with accessible content files. By allowing the load balancer 120 to function across servers 110 with accessible content during the updating process, the load balancer 120 can detect any sudden spikes in load on the available servers 120 and direct incoming client requests to other available servers (i.e., can balance the load among the available servers). With the intelligent content distributor 200, the site never loses its ability to properly balance the incoming client requests among the available servers based on their capacity and availability.

When the intelligent content distributor 200 is ready to publish the content to a web server 110, the intelligent content distributor 200 sends a request to the load balancer 120 to redirect the “http” requests for content away from that web server 110 that is being updated. After the request is confirmed by the load balancer 120, the intelligent content distributor 200 publishes the content to the web server's file system. This process is repeated until all the web servers 110 in the web server farm or cluster 100 are updated. After the intelligent content distributor 200 successfully publishes the content to a percentage of the web servers 110, the intelligent content distributor 200 initiates the switching process. During the switching process, the intelligent content distributor 200 requests the load balancer 120 to direct the “http” or client requests for content only to those web servers 110 with the newly published content. In other words, all other web servers 110 are made unavailable for such “http” request until they are updated with the newly published content.

In accordance with an embodiment of the present invention, the content redirection table can be implemented as two tables: a content-redirect table and a batch table. The content-redirect table includes a list of all unavailable content and hashed URI. For each URI, the content-redirect table has a list of all unavailable servers. When the content becomes available on a particular server, the server name is removed from the server list. When the server list is empty, the entry is then completely removed from the table. For example, the content-redirect table can include the following entries:

CONTENT _REDIRECT

CONTENT_REDIRECT
{
URI,
FILEMODE,
SERVER LIST
}

The batch table includes multiple URI entries that are to be made unavailable as group in a batch job, identified or keyed by a batch id. When a Commit Unavail message is received, the entire URI entries in the a batch job is inserted to the content-message table, thereby making such URIs unavailable to the end user. When such URIs or content associated with the URIs are made later available (i.e., Commit Avail message is received), these URI entries in the batch job are removed from the content-redirect table. For example, the batch table can include the following entries:

BATCH

BATCH
{
BATCH ID,
URI_ENTRY LIST, // list of (URI, FILEMODE)
SERVER_LIST,
}
URI_ENTRY
{
URI,
FILEMODE
}

Message Format:
Message_Type|Content_Status|JOB_ID|MESSAGE_ID|SERVER|DOCROOT|FILEMODE|URI

Message_Type|Content_Status|JOB_ID|MESSAGE_ID|SERVER|DOCROOT|FILEMODE|URI

Message_Type: SET, COMMIT

Content_Status: AVAIL, UNAVAIL, UNAVAILREADY

Process_ID: the Job id related to this message.

Message_ID: unique message identifier for this job id

Server Name: host name for which the content is intended to.

DOC_ROOT: Document root directory for the server.

FILEMODE: File mode for the URJ in the form of 3 digits. If no change is required in the file mode, an invalid file mode can be used, such as “AAA”.

URI—URI associated with the content.

Message Types and Description for Plug-in Module (PM) and Load Balancer (LB):

1. Set-Unavailable message is sent when the intelligent content distributor 200 needs to make a URI unavailable for a particular server 110 immediately.

SET|UNAVAIL|JOBID|MSG_ID|SERVER|DOCROOT|FILE_MODE|URI

LB: The URI is used to search the content-redirection table. If no entry found, URI is inserted and the server name is inserted to the URI's server list, thereby making the URI unavailable on this particular server. FILE_MODE is not used.

PM: Pre-Action: copies URI to TEMP location; Post-Action: none.

After the message is sent, the request for the URI is re-directed to the TEMP location by the name translation module.

2. Set-Avail message is sent when the intelligent content distributor 200 wants to make an updated content, i.e., URI, available for a server immediately.

SET|AVAIL|JOBID|MSG_ID|SERVER|DOCROOT|FILE_MODES|URI

LB: The load balancer 120 searches the content-redirection table for a particular URI. If match is found, the server is removed from the server list. When the server list is empty, the specific URI entry is removed from the content-redirection table. If FILE_MODE is valid, the file mode for file $DOC_ROOT/URI is changed to the FILE_MODE.

PM: Pre-Action: none; Post-Action: removes the URI from temporary location.

3. Set-Unavail-Ready message is sent to setup a batch of URI list. The whole batch can be set as unavailable or available for a server at the same time through Commit message.

SET|UNAVAILREADY|JOBID|MSG_ID|SERVER|DOCROOT|FILE_MODE|URI

LB: JOBID is used as a batch job id and is also used as a key to search the batch table. If no entry is found, the JOBID is inserted into the batch table. The URI is used as key to search the URI list of the batch job. If such URI is not in the URI list, then a new URI_FILE_MODE entry is inserted to the batch job. The SERVER and DOCROOT fields are not used.

PM: Pre-Action: copies URI to TEMP location; Post-Action: none.

4. Commit Unavail message makes a batch of URIs unavailable for a server.

COMMIT|UNAVAILREADY|JOBID|MSG-ID|SERVERNAME|DOCROOT

LB: The JOBID is used as key to search the batch table. Every URI in the URI list is paired with a server name. The pair is then inserted into the content-redirection table. The SERVERNAME is inserted to the server list of the batch and the DOCROOT is saved to DOCROOT list. The URI and FILE MODE fields are not used.

PM: Pre-Action: none; Post-Action: none.

5. Commit Avail message makes a batch of URIs available for a server.

COMMIT|AVAIL|JOBID|MESSAGE_ID|SERVER|DOCROOT

LB: The JOBID is used as key to search the batch table. For each URI in the URI list, the load balancer 120 searches the content-redirection table for a matching URI. The SERVER is then removed from the URI's server list. When the server list is empty, the specific URI entry is removed from the batch table. The server is also removed from server list of the batch. When the server list is empty, the batch entry is removed from batch table. For each URI, if the FILE_MODE in URI list is valid, the file mode for file $DOC_ROOTLURI is changed to the FILE_MODE.

PM: Pre-Action: none; Post-Action: none.

6. Switch Non-Batch message is sent when the intelligent content distributor performs a switch process for a non-atomic job.

SWITCH|NON_BATCH|JOBID|MSGID|URI|UNAVAIL_SERVER_LIST|AVAIL_SRV_LIST AVAIL_SERVER_LIST and UNAVAIL_SRV_LIST is a comma-separated string.

LB: The URI is used to search the content-redirection table. The server list is replaced the UNAVAIL_SERVER_LIST. The AVAIL_SRV_LIST is for only for integrity check. If the server switches from unavailable to available and the FILEMODE for file DOCROOT/URI is valid, the file mode is changed to FILEMODE.

PM: Pre-Action: none; Post-Action: Removes the URI from temporary location.

7. Switch Batch message is used to perform a switch process for atomic job.

SWITCH|BATCH|JOBID|MSGID|URI|UNAVAIL_SERVER_LIST|AVAIL_SRV_LIST AVAIL_SERVER_LIST and UNAVAIL_SRV_LIST is a comma-separated string.

LB: JOBID is used as batch id to search the batch table. After the batch is found, each URI in its URI list is used to find an URI entry in the content-redirection table. For each URI found, its server list is replaced by UNAVAIL_SRV_LIST. The URI field is not used. The server list in the batch table is replaced with UNAVAIL_SERVER_LIST. The AVAIL_SRV_LIST is used only for integrity check. If the server is switched from unavailable to available, for each (URI, FILEMODE) pair, the file mode for file DOCROOT/URI is changed to FILEMODE. The DOCROOT is in the DOCROOT list of the batch job.

PM: Pre-Action: none; Post-Action: Remove the URI from temporary location.

The intelligent content distributor 200 combined with load balancer provides a site with seamless content-aware load balancing capabilities. Sites relying on switches or central scheduling devices for their Internet solutions, cannot achieve content-aware load balancing at the high levels of reliability and site performance that the intelligent content distributor 200 operating with a load balancer 120 can deliver.

Adding content status awareness features to any central device takes up processing power and limits the device's overall basic load balancing abilities. Adding this complexity to a central device ensures that device-dependent sites will quickly require upgrades to the switch or central scheduler to deal with increasing Internet traffic at the site.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A method for intelligently updating content in a server cluster having a plurality of servers to provide consistent data, comprising the steps of:
(a) storing pre-existing content on a server that is being updated in a temporary location;
(b) updating said server with said content;
(c) inhibiting said server from accepting requests for said content and redirecting requests for said content in said server to said temporary location;
(d) repeating steps (a) and (c) until each server is updated;
(e) determining if said content has been successfully updated on each server;
(f) storing said pre-existing content in a staging server and enabling said server to accept requests for said content if it is determined that said content has been successfully updated; and
(h) restoring said pre-existing content to each server and enabling said server to accept requests for said pre-existing content if it is determined that said content has not been successfully updated.

2. The method of claim 1, wherein said content is a file or directory.

3. The method of claim 1, wherein said content is a group of file s or directories.

4. The method of claim 3, wherein said content is an atomic content; and wherein the step (d) determines if said group of files or directories have been successfully updated.

5. The method of claim 3, wherein said content is a non-atomic content; and wherein the step (d) determines for each file or directory if said each file or directory has been successfully updated.

6. The method of claim 1, wherein said content represents file or directory to be removed from said server; and wherein the step (b) deletes said content from said server.

7. The method of claim 1, wherein said content represents content stored in said staging area; and wherein the step (b) restores said stored content to said server.

8. A method for intelligently updating content in a server cluster having a plurality of servers to provide consistent data, comprising the steps of:
(a) storing pre-existing content on a server that is being updated in a staging server;
(b) updating said server with said content;
(c) inhibiting said server from accepting requests for said content by a load balancer;
(d) determining if a predetermined server threshold has been met for said content;
(e) permitting said server from accepting said requests and inhibiting servers that has not been updated with said content from accepting requests if it is determined that said predetermined server threshold has been met;
(f) repeating steps (a) and (e) until each server is updated; and
(g) restoring said pre-existing content to each server and enabling said server to accept requests for said pre-existing content if it is determined that said predetermined server threshold has not been met.

9. The method of claim 8, wherein said content is a file or directory.

10. The method of claim 8, wherein said content is a group of files or directories.

11. The method of claim 10, wherein said content is an atomic content; and wherein the step (d) determines if said server threshold has been met for said group of files or directories.

12. The method of claim 10, wherein said content is a non-atomic content; and wherein the step (d) determines for each file or directory if said server threshold has been met for said each file or directory.

13. The method of claim 8, wherein said content represents file or directory to be removed from said server; and wherein the step (b) deletes said content from said server.

14. The method of claim 8, wherein said content represents content stored in said staging area; and wherein the step (b) restores said stored content to said server.

15. An intelligent content distributor for intelligently updating content in a server cluster having a plurality of servers to provide consistent data, comprising:
a console for generating a job for updating said cluster with said content;
a scheduling for scheduling said job; and
an executor for executing said job for each server in said server cluster, wherein said job comprises: storing pre-existing content on a server that is being updated in a temporary location, updating said server with said content, inhibiting said server from accepting requests for said content and redirecting requests for said content in said server to said temporary location, and determining if said content has been successfully updated on said server; and
wherein said executor is operable to store said pre-existing content in said intelligent content distributor and enabling said plurality of servers to accept requests for said content if it is determined that said content has been successfully updated; and
wherein said executor is operable to restore said pre-existing content to each server and enabling said plurality of servers to accept requests for said pre-existing content if it is determined that said content has not been successfully updated.

16. The intelligent content distributor of claim 15, wherein said job comprises publishing, deleting or restoring content.

17. The intelligent content distributor of claim 15, wherein said scheduler is operable to reschedule said job if it is determined that said content has not been successfully updated.

18. An intelligent content distributor for intelligently updating content in a server cluster having a plurality of servers to provide consistent data, comprising:
a console for generating a job for updating said cluster with said content;
a scheduler for scheduling said job;
an executor for executing said job for each server in said server cluster, wherein said job comprises: storing pre-existing content on a server that is being updated in said intelligent content distributor, updating said server with said content, and determining if a predetermined server threshold has been met for said content; and
a load balancer for inhibiting a server that has been updated with said content and from accepting requests until it is determined that said predetermined threshold has been met; and
wherein said executor is operable to restore said pre-existing content to each server and enabling said plurality of servers to accept requests for said pre-existing content if it is determined that said predetermined threshold has not been met.

19. The intelligent content distributor of claim 15, wherein said job comprises publishing, deleting or restoring content.

20. The intelligent content distributor of claim 15, wherein said scheduler is operable to reschedule said job if it is determined that said predetermined threshold has not been met.
